(19) United States
(12) Patent Application Publication
(10) Pub. No.: US 2014/0270072 A1
(43) Pub. Date: Sep. 18, 2014

(54) GRAIN SIZE INSPECTION OF A GAS TURBINE COMPONENT BY X-RAY REFRACTION

(71) Applicants: ROBERT L. MCCORMICK, JUPITER, FL (US); JOSEPH YOUNG, PORT SAINT LUCIE, FL (US); ADAM L. HART, STUART, FL (US)

(72) Inventors: ROBERT L. MCCORMICK, JUPITER, FL (US); JOSEPH YOUNG, PORT SAINT LUCIE, FL (US); ADAM L. HART, STUART, FL (US)

(73) Assignees: ROBERT L. MCCORMICK, JUPITER, FL (US); ADAM L. HART, STUART, FL (US); JOSEPH YOUNG, PORT SAINT LUCIE, FL (US)

(21) Appl. No.: 14/203,815

(22) Filed: Mar. 11, 2014

Related U.S. Application Data
(60) Provisional application No. 61/779,700, filed on Mar. 13, 2013.

(51) Int. Cl. G01N 15/02; G01N 23/04

(52) U.S. Cl. CPC G01N 15/0227; G01N 23/04
USPC 378/62

(57) ABSTRACT

A system and method for inspecting a grain size of a cast alloy component while maintaining the structural integrity of the cast alloy component is disclosed. The method includes recording a radiographic image of the component, identifying areas of the component to be inspected, and locating one or more lines having a pre-determined length on the radiographic image at an area to be inspected. Then, a total number of intersections with the one or more lines are determined and an average grain size is calculated.

### CROSS REFERENCE TO RELATED APPLICATIONS

This application claims priority to U.S. Provisional Patent Application Ser. No. 61/779,700 filed Mar. 13, 2013.

### TECHNICAL FIELD

The present invention relates to gas turbine engines. More particularly, embodiments of the present invention relate to an improved inspection technique of cast gas turbine components using x-ray refraction to determine grain sizes.

### BACKGROUND OF THE INVENTION

A gas turbine engine operates to produce mechanical work or thrust. For a land-based gas turbine engine, a generator is typically coupled to the engine through an axial shaft, such that the mechanical work of the engine is harnessed to generate electricity. A typical gas turbine engine comprises a compressor, at least one combustor, and a turbine, with the compressor and turbine coupled together through the axial shaft. In operation, as air passes through multiple stages of axially-spaced rotating blades and stationary vanes of the compressor, its pressure increases. The compressed air is then mixed with fuel in the combustion section, which can comprise one or more combustion chambers. The fuel-air mixture is ignited in the combustion chamber(s), producing hot combustion gases, which pass into the turbine causing the turbine to rotate. The rotation of the shaft also drives the generator.

Turbine blades and vanes are commonly cast using a vacuum or air-cooled casting process and often include a plurality of cooling passages and complex geometry. It is also desirable that turbine blades have as low of a weight as possible because of the stresses created by the blade weight spinning at high revolutions per minute. Therefore, while blades and vanes can be manufactured with relatively thin walls, it is necessary to properly grain inspect the blades and vanes prior to entry into service, because casting grain defects smaller than those visible to the naked eye can occur, and very small casting defects can cause premature failure of the turbine blade or vane due to creep.

### SUMMARY

Embodiments of the present invention are directed towards a method of inspecting the grain size of cast alloy components and quickly identifying chill grain and hard transitions from an acceptable grain size to an abrupt change in grain size.

In an embodiment of the present invention, a method of inspecting a grain size of a cast alloy component while maintaining the structural integrity of the cast alloy component is disclosed. The method includes recording a radiographic image of the component, identifying areas of the component to be inspected, and locating one or more lines at a radial position along the airfoil with the one or more lines having a pre-determined length. Then, a total number of intersections with the one or more lines is determined and an average grain size is calculated.

In an alternate embodiment of the present invention, a non-destructive radiographic inspection technique for determining a grain size of a gas turbine casting is disclosed. The non-destructive inspection technique comprises the steps of identifying a series of inspection areas from a radiographic image of the casting, locating one or more lines having a pre-determined length on the radiographic image at a radial position on the casting. A total number of intersections of the grain boundaries with the one or more lines are determined. The average grain size is calculated based on the ratio of line length to total number of intersections.

In yet another embodiment of the present invention, a computer readable media for determining a grain size of a cast turbine component is disclosed. The computer readable media performs the steps of recording a radiographic image of the component, identifying areas of the component to be inspected, locating one or more lines having a pre-determined length on the x-ray image at one of the areas to be inspected, calculating a total number of intersections of grain boundaries with the one or more lines, and calculating an average grain size.

Additional advantages and features of the present invention will be set forth in part in a description which follows, and in part will become apparent to those skilled in the art upon examination of the following, or may be learned from practice of the invention.

### DESCRIPTION OF FIGURES

FIG. 1 is a flow diagram of a non-destructive method for inspecting a grain size a cast alloy component in accordance with an embodiment of the present invention;

FIG. 2 is a depiction of a non-destructive method for inspecting a grain size of a cast alloy component in accordance with an embodiment of the present invention;

FIG. 3 is a table of data from an example of grain size measurements using the non-destructive method for inspecting a grain size of a cast alloy component in accordance with an embodiment of the present invention;

FIG. 4 is a table of data of grain size measurements from a prior art method for inspecting a grain size of a cast alloy component;

FIG. 5 depicts a series of images comparing the non-destructive method for inspecting a grain size of a cast alloy component in accordance with an embodiment of the present invention with a prior art destructive method; and

FIG. 6 depicts images comparing the non-destructive method for inspecting a grain size of a cast alloy component in accordance with an embodiment of the present invention with a prior art etch surface method for inspecting a grain size of a cast alloy component.

### DESCRIPTION OF THE PREFERRED EMBODIMENT

The subject matter of the present invention is described with specificity herein to meet statutory requirements. However, the description itself is not intended to limit the scope of this patent. Rather, the inventors have contemplated that the claimed subject matter might also be embodied in other ways, to include different components, combinations of components, steps, or combinations of steps similar to the ones described in this document, in conjunction with other present or future technologies.

As discussed above, gas turbine blades and vanes are typically cast components made from a high temperature alloy. In order to provide for adequate cooling given their high operating temperatures, the internal portions of the blades and vanes are often air cooled. As such, the blades and vanes typically have relatively thin walls. However, due to the aerodynamic and mechanical stresses imparted on the blades and vanes, and with such relatively thin walls, it is critically important to determine whether or not the cast blades and vanes have any internal defects as a result of the casting process as well as the average grain size.

As one skilled in the art understands, there are three general types of casting processes used for making gas turbine blades and vanes—equiaxed, directionally-solidified and single crystal. Each of these three types of casting are manufactured by slight variations to an investment casting process, also referred to as lost wax processing. In this process, a wax body of the desired blade or vane is formed. If the blade or vane is to be hollow, the wax mold includes a ceramic core conforming to the shape of the internal portion of the blade or vane. The wax blade or vane is then coated in a heat-resistant material to form a shell. The wax material is them melted from within the shell to form a void conforming to the shape and size of the blade or vane. The shell is then filled with a liquid metal. It is how the liquid metal is cooled that determines the type of casting, and also the relative strength of the blade or vane. Once cool, the outer shell is knocked off of the casting and if there is a core in the blade or vane, the ceramic core is chemically leached out of the cast part, leaving the blade or vane hollow.

As discussed above, it is the manner in which the casting is cooled that determines the style of casting—equiaxed, directionally solidified or single crystal. For the equiaxed casting process, the liquid metal is allowed to cool without further direction. As such, the liquid metal forms various grains that vary in size, shape and orientation. While the equiaxed casting process is relatively simple, it is also primarily used for lower stressed parts due to the fact that the equiaxed castings generally have a lower strength compared to directionally solidified and single crystal castings.

For a directionally solidified casting, once the liquid metal is poured into the shell, the shell is withdrawn from the furnace at a controlled rate in a specified direction, so as to cause the casting cool in a way that causes the grains within the casting to extend or “grow” in the direction the part is cooled. With the grains all oriented in a single direction to cast component will have a greater capability with respect to component stress levels.

Finally, with respect to single crystal castings, or a monocrystalline solid, this is a casting where the turbine component is “grown” from a single seed such that the crystal lattice of the entire component is continuous and unbroken, that is with no grain boundaries. The absence of the grain boundaries gives this type of casting superior properties, especially mechanical properties.

While directionally solidified and single crystal castings are preferred from a mechanical standpoint, they are more costly to produce. As such, it can be more desirable to fabricate a turbine blade or vane from an equiaxed casting. However, it is critical to be able to inspect the grains of these castings to ensure they meet certain predetermined requirements. One such requirement is that the grains meet an average grain size. Average grain size is determined by measuring the number of grains positioned across a distance a specified distance.

Referring to FIGS. 1-3 and 5-7, the system and method for inspecting a grain size of a cast alloy component while maintaining the structural integrity of the cast alloy component is disclosed. Referring now to FIG. 1, the method 100 of the present invention is depicted in a flow diagram while the process is depicted pictorially in FIG. 2. The method 100 provides a non-destructive radiographic inspection technique for determining a grain size of a gas turbine casting comprising a step 102 of recording a radiographic image of the component to be inspected. One such example is an x-ray image of a turbine blade or vane cast with an equiax grain structure. Then, in a step 104, the areas of the component to be inspected are identified. The areas typically identified for inspection, such as region 204 shown in FIG. 2, are located generally along an airfoil 200 of the blade 202 or vane. However, due to the complex airfoil geometry and varying airfoil thickness at different locations, it is necessary to inspect a number of regions 204. These regions 204 are spaced along the airfoil at different radial locations.

Once the radiographic image has been recorded and the areas to be inspected have been identified, in a step 106, one or more lines 206 having a predetermined length are located on the radiographic image. While the predetermined length of the one or more lines 206 can vary in length, one such accepted length for the line 206 is approximately 0.5 inches. As shown in FIG. 2, it is possible that multiple lines 206 are located within a single region 204.

Next, in a step 108, a determination is made as to the total number of intersections of grain boundaries with the one or more lines 206. This determination can be made by an operator visually inspecting the radiographic image. Representative images of the number of intersections for four different samples blades are depicted in FIG. 2. Then, in a step 110, a determination is made as to the average grain size. The average grain size is calculated by dividing the length of the line 206 by the number of interactions with the line 206. For example, with reference to FIG. 2, sample 1 averaged twelve interactions with the line 206 at a portion along the airfoil. The line 206 extends approximately 0.5 inches. Therefore, the average grain size for the equiax casting at this location is approximately 0.042 inches. It has been determined that through such a process, it is also possible to identify chill grains as small as 0.020 inches. This process allows for identification of a hard transition. More specifically, chill grain located within a component may be non-destructively found to identify the transition from an average grain structure to chill grain structure. Known prior art processes do not have the capability to non-destructively detect this transition.

In a step 112, a determination is made as to whether or not additional lines are needed to determine grain boundary intersection. If so, then the process returns to the step 108 where a total number of intersections with another line is determined. If a sufficient number of grain boundary intersections have been determined, then the process is completed at step 114.

The process outlined in FIG. 1 and shown pictorially in FIG. 2 can also be accomplished by a form of computer readable media stored on a computing device. Computer-readable media can be any available media that can be accessed by computing device and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium that can be used to store the desired information and that can be accessed by the computing device. Computer storage media does not comprise signals per se. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Where such a computing device utilizes computer readable media for purposes of determining the grain size of the casting, the process may also require input from an operator. More specifically, an operator input may be required to identify which region of the airfoil to calculate the grain size, which line to use from the radiographic image, or for other areas of input.

Referring now to FIG. 3, a table of data listing average grain size at the mid span region of a turbine component is provided for the series of sample castings depicted in FIG. 2. More specifically, four different samples are listed, each with a corresponding line, number of interceptions with the line, a grain size, and an average grain size when averaging the multiple line locations, a maximum grain size and a minimum grain size. For example, for Part ID 464A, three line locations are present, locations 1-3. As it can be seen from FIG. 2, the line location number corresponds to a radial location along the airfoil 200. Referring to FIGS. 2 and 3, at each radial location 1, 2, and 3, there are multiple lines, A, B, and C. Therefore, for the line C of location 3 for Part ID 464A, there are 12 grain boundaries intercepting the line. As the line C measures 0.5 inches long, the grain size is determined to therefore be 0.042 inches. An analysis of the number of intercepts through multiple lines at multiple locations results in an average grain size of 0.042 inches for Part ID 464A. As shown in FIG. 3 the measurements of the grain size provide statistics for grain interpretation. Particularly, the measurements provide size and uniformity for either a single plane of reference or multiple planes of reference.

FIG. 4 is a chart depicting grain size measurements and average grain size values for the same components discussed in FIG. 3. However, the process used to determine the grain size in FIG. 4 is one of the ways known in the prior art—a visual inspection of the surface grains. As it can be seen from FIG. 4, for the same Part ID 464A discussed above, for the third line of intercepts (the same radial location on the airfoil), only seven intercepts were measured when using the method of the prior art, resulting in a grain size of 0.036 inches. This result is drastically different than, and less accurate, than the method of the present invention, which for the same part, in the same region, determined there to be 12 grain boundaries and a grain size of 0.042 inches. The average grain size determined by the prior art method of FIG. 4 results in a grain size of 0.047 inches, whereas the present invention yields a more accurate grain size of 0.042 inches.

Referring now to FIG. 5, a series of images compare the present invention method for determining grain size with a method of the prior art. The present invention provides a non-destructive way of determining grain size through radiographic inspection, where the method of the prior art in FIG. 5, measures the grain size through a destructive method of cutting the casting an examining a cross section of the casting.

Referring now to FIG. 6, a series of images are shown comparing the method of the determining grain size in accordance with the present invention with an alternate method of the prior art. The alternate method of the prior art for which images of grain size are shown in FIG. 6 is a grain etch. The grain etch process did not properly identify very fine grain sizes chill grain and the lack of identifying correct grain sizes can lead to stress rupture of the castings.

The present invention has been described in relation to a particular embodiment, which is intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and sub-combinations are of utility and may be employed without reference to other features and sub-combinations. This is contemplated by and within the scope of the claims.

What is claimed is:

1. A method of inspecting a grain size of a cast alloy component while maintaining the structural integrity of the cast alloy component comprising:
recording a radiographic image of the component;
identifying areas of the component to be inspected;
locating one or more lines having a pre-determined length on the radiographic image at one of the areas to be inspected;
calculating a total number of intersections of grain boundaries with the one or more lines; and
calculating an average grain size.

2. The method of claim 1, wherein the cast alloy component is a turbine blade or turbine vane.

3. The method of claim 2, wherein the cast alloy component is cast with an equiax grain or directionally-solidified structure.

4. The method of claim 3, wherein the areas of the cast alloy component to be inspected are located along an airfoil.

5. The method of claim 4, wherein the areas to be inspected along the airfoil are spaced at different radial locations.

6. The method of claim 1, wherein the pre-determined length of the one or more lines is approximately 0.5 inches.

7. The method of claim 1, wherein the average grain size is calculated based on the ratio of the length of the line to number of intersections.

8. The method of claim 2, wherein multiple lines are located within a single radial section of the airfoil.

9. The method of claim 1, wherein the method is capable of identifying a chill grain as small as 0.020″ in the cast alloy component.

10. The method of claim 1, wherein calculating the number of intersections is determined by an operator upon visual inspection of the radiographic image.

11. The method of claim 1, wherein the areas of the component to be inspected are determined by an operator.

12. A non-destructive radiographic inspection technique for determining a grain size of a gas turbine casting comprising:
identifying inspection areas from a radiographic image of the casting;
locating one or more lines having a pre-determined length on the radiographic image at a radial orientation on the casting; and,
determining a total number of intersections of grain boundaries with the one or more lines;
wherein an average grain size is calculated based on the ratio of line length to total number of intersections.

13. The inspection technique of claim 12, wherein the inspection areas are located generally along an airfoil portion of the turbine casting.

14. The inspection technique of claim 12, wherein the one or more lines extend a length of approximately 0.5 inches.

15. The inspection technique of claim 12, wherein determining the total number of intersections of grain boundaries with the one or more lines is made by an operator.

16. The inspection technique of claim 12, wherein the cast alloy is an equiax casting.

17. A computer readable media for determining a grain size of a cast turbine component comprising:
recording a radiographic image of the component;
identifying areas of the component to be inspected;
locating one or more lines having a pre-determined length on the x-ray image at one of the areas to be inspected;
calculating a total number of intersections of grain boundaries with the one or more lines; and
calculating an average grain size.

18. The computer-readable media of claim 17, wherein calculating the average grain size is calculated based on a ratio of line length to total number of intersections.

19. The computer-readable media of claim 17, wherein the inspection areas are located generally along an airfoil portion of a turbine casting.

20. The computer-readable media of claim 17, wherein calculating the total number of intersections of grain boundaries with the one or more lines requires input from an operator.
